(19) United States
(12) Patent Application Publication
(10) Pub. No.: US 2026/0244247 A1
(43) Pub. Date: Aug. 20, 2026

(54) WATERDROP TYPE HINGE MODULE FOR FOLDABLE MOBILE TERMINAL AND FOLDABLE MOBILE TERMINAL USING THE SAME

(71) Applicant: PARTSTEC CONSTRUCTION CO., LTD, Gumi-si (KR)

(72) Inventors: Young Tak Lee, Gumi-si (KR); Kil Seok Jeong, Gumi-si (KR)

(21) Appl. No.: 19/079,548

(22) Filed: Mar. 14, 2025

(30) Foreign Application Priority Data
Feb. 18, 2025 (KR) 10-2025-0020981

(51) Int. Cl. G06F 1/16

(52) U.S. Cl. CPC G06F 1/1681; G06F 1/1679

(57) ABSTRACT

The present disclosure relates to a waterdrop type hinge module for a foldable mobile terminal that prevents damage to a flexible display by forming the folded portion of the flexible display into a waterdrop shape when a foldable mobile terminal is folded, and a foldable mobile terminal using the waterdrop type hinge module. In particular, the present disclosure enables a mobile terminal to be stably rotated and stably maintain an angle in an unfolded state or folded state by means of guide groves formed on a swing cam of a swing plate and guide protrusions formed on a base body.

### CROSS REFERENCE TO RELATED APPLICATIONS

The present application claims the benefit of Korean Patent Application No. 10-2025-0020981 filed on Feb. 18, 2025, the contents of which are incorporated herein by reference in their entirety.

### TECHNICAL FIELD

The present disclosure relates to a waterdrop type hinge module for a foldable mobile terminal, and a foldable mobile terminal using the same. In particular, the present disclosure relates to a waterdrop type hinge module for a foldable mobile terminal that prevents damage to a flexible display by forming the folded portion of the flexible display into a waterdrop shape when a foldable mobile terminal is folded, and a foldable mobile terminal using the waterdrop type hinge module.

### BACKGROUND ART

In general, a flexible display panel is a display panel that can be bent with a predetermined curvature.

Such flexible display panels employ a plastic substrate rather than a glass substrate that is generally used, so a low-temperature manufacturing processor is generally used rather than existing manufacturing processors to prevent damage to the substrate.

Such flexible display panels are manufactured, for example, as touch screens enabling capacitive or pressure-sensitive touch input to be able to receive user commands in a touch type.

Meanwhile, the mobile foldable display devices of the related art, that is, foldable mobile terminals are equipped with a flexible display panel that enables touch input, as described above.

In the foldable mobile terminals of the present disclosure, a predetermined accommodation space enabling the folding portion of a flexible display panel to be bent in a curved shape is formed at the hinged portion of a pair of bodies supporting the flexible display panel.

Various hinge modules for opening/closing such flexible displays are currently being developed.

However, most hinge modules are complicated in structure, have many parts, are thick at the folding portion, and generate a gap between the portions facing each other when a flexible display are folded, so they are at risk of damage due to ingress of foreign substances and impacts.

In particular, the center portion where the flexible displays are folded needs to form a waterdrop shape with a narrow upper portion and a wide lower portion to prevent damage and concentration of load when it is folded, but the hinge modules of the related art have limitations in perfectly implementing this shape.

In order to solve these problems, the applicant has developed a hinge module disclosed in Korean Patent No. 10-2644316.

According to the hinge module of Korean Patent No. 10-2644316, in order to maintain a state in which mobile terminals are closed or unfolded, a first insertion portion and a second insertion portion are concavely formed on the outer surface of an end of a second lever and a bent stopping protrusion is formed at both ends of a plate spring such that the stopping protrusions can be inserted into the first and second insertion portions.

However, as a result of repeatedly testing the structure described above, the applicant discovered that the hinge module is not operated smoothly at the point where it is closed or unfolded, and there was a need to ensure that a foldable terminal more stably maintains the angle when it is unfolded or folded while stably rotating.

### CITATION LIST

### Patent Literature

### [Patent Literature 1]

Korean Patent No. 10-2542066

### [Patent Literature 2]

Korean Patent No. 10-2714562

### [Patent Literature 3]

Korean Patent No. 10-2644316

### SUMMARY OF INVENTION

### Technical Problem

The present disclosure has been made in an effort to solve the problems described above, and an objective of the present disclosure is to provide a waterdrop type hinge module for a foldable mobile terminal that enables a center portion of a flexible display, which is folded when a foldable mobile terminal is folded, to stably form a waterdrop shape, that enables more smooth operation at a point where the hinge module is closed or unfolded, and that enables a mobile terminal to more stably maintain an angle when it is unfolded or folded while stably rotating, using a relatively simple structure and a small number of parts, and a foldable mobile terminal using the waterdrop type hinge module.

### Solution to Problem

In order to achieve the objectives described above, a waterdrop type hinge module for a foldable mobile terminal of the present disclosure includes: a base body; a pair of swing sliders spaced apart from each other at both sides of the base body and coupled at one end to the base body to be rotatable upward and downward; a synchronization element synchronizing rotation of the pair of swing sliders spaced apart from each other by connecting the swing sliders; a pair of swing plates spaced apart from each other at both sides of the base body, having an arc-shaped swing cam formed at an end and coupled to the base body to be rotatable upward and downward, and forming a waterdrop shape with a narrow upper portion and a wide lower portion at a folding portion of a flexible display mounted in a mobile terminal when the mobile terminal is closed; a plate spring coupled and fixed to the base body and being in contact with an outer surface of the pair of spaced swing cams at both ends; and a slide block hinged at an upper end to the swing plate to be rotatable, having the swing slider coupled to a lower end to be slidable, and coupled and fixed to the mobile terminal, wherein a guide groove is formed on an outer surface of the swing cams along the outer surface of the swing cams and guide protrusions that are inserted in the guide grooves when the swing plates are rotated are formed on the base body.

The guide grooves are formed at both sides of a center potion of the swing cam that is in contact with the plate spring, and the guide protrusions protrude at both sides of the plate spring.

The base body is formed by coupling an upper body disposed over the swing cam and a lower body disposed under the swing cam, and the guide protrusions protrude upward from the lower body.

Fixing protrusions protrude downward from the upper body, through-holes are formed at the plate spring, fastening holes are formed at the lower body, and when the upper body and the lower body are coupled, the fixing protrusions pass through the through-holes and the fastening holes to fix the plate spring.

A first locking step is formed at the guide protrusion, a second locking step is formed at an end of the guide groove, and when the swing plate is rotated over 90 degrees, the second locking step comes in contact with the first locking step, thereby limiting a rotation angle of the swing plate.

A supporting step is formed at the other end of the guide groove, and when the swing plate is unfolded to be horizontal, the supporting step comes in contact with the first locking step such that the swing plate maintains the horizontally unfolded state.

A seating groove is formed on the other surfaces that are surfaces opposite of one surfaces facing each other of the pair of swing plates, and when the swing plate is rotated over 90 degrees, the slide block is rotated about an upper end hinged to the swing plate and is inserted into the seating groove, thereby supporting the swing plate.

An inclined surface is formed on the one surface facing the other surface of the swing plate, and when the swing plate is rotated over 90 degrees, the inclined surface of the slide block comes in contact with the second surface of the swing plate that is disposed at an angle.

When the folding portion of a flexible display is formed in a waterdrop shape with a narrow upper portion and a wide lower portion by the pair of swing plates, the slide block and the swing slider coupled to the mobile terminal is rotated 90 degrees from a horizontal state, and the swing plate is rotated over 90 degrees from a horizontal state.

Further, a foldable mobile terminal is characterized by being equipped with the hinge module of the present disclosure.

### Advantageous Effects of Invention

According to the waterdrop type hinge module for a foldable mobile terminal and a foldable mobile terminal using the waterdrop type hinge module described above, there are effects as follows.

The present disclosure enables a folded center portion of a flexible display to be folded while stably forming a waterdrop shape when the foldable mobile terminal is folded, and the folding center portion of the flexible display completely forms a waterdrop shape, so it is possible to prevent the flexible display from being damaged or prevent large load from being applied thereto while it is folded, thereby being able to improve durability.

Further, since the structure configuring the hinge module is relatively simple and is composed of a relatively small amount of parts, it is possible to improve productivity, ease of assembly, and workability.

In particular, the present disclosure enables a mobile terminal to be stably rotated and stably maintain an angle in an unfolded state or folded state by means of guide groves formed on a swing cam of a swing plate and guide protrusions formed on a base body.

### BRIEF DESCRIPTION OF DRAWINGS

FIG. 1 is a perspective view showing an unfolded state of a hinge module according to an embodiment of the present disclosure.

FIG. 2 is an exploded perspective view of the hinge module according to an embodiment of the present disclosure seen in one direction.

FIG. 3 is an exploded perspective view of the hinge module according to an embodiment of the present disclosure seen in another direction.

FIG. 4 is a bottom perspective view of a swing cam according to an embodiment of the present disclosure.

FIG. 5 is a perspective view of guide protrusions according to an embodiment of the present disclosure.

FIG. 6 is a perspective view showing a folded state of the hinge module according to an embodiment of the present disclosure.

FIG. 7A and FIG. 7B are a cross-sectional view of the hinge module according to an embodiment of the present disclosure cut at the plate spring portion.

FIG. 8A and FIG. 8B are a cross-sectional view of the hinge module according to an embodiment of the present disclosure cut at the guide protrusion portion.

FIG. 9A and FIG. 9B are a cross-sectional view of the hinge module according to an embodiment of the present disclosure cut at the sliding block portion.

FIG. 10 is a lateral view showing the state in which a flexible display has been mounted on the hinge module according to an embodiment of the present disclosure.

### DESCRIPTION OF EMBODIMENTS

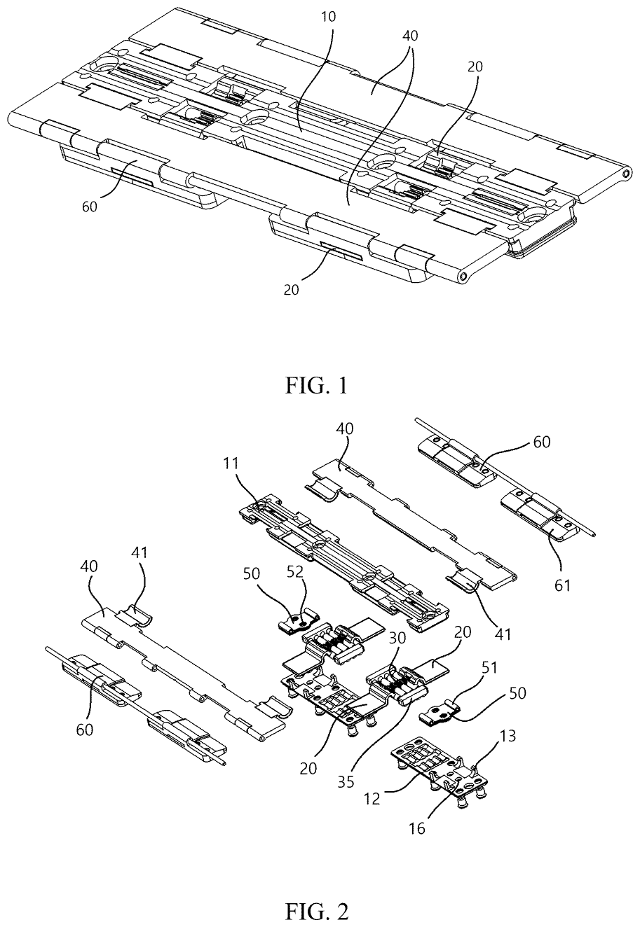

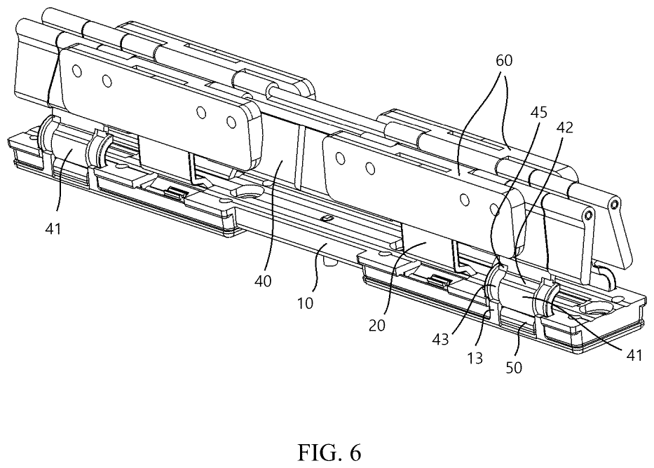

A waterdrop type hinge module for a foldable mobile terminal of the present disclosure, as shown in FIG. 1 to FIG. 6, includes a base body 10, a swing slider 20, a synchronization element 30, a swing plate 40, a plate spring 50, and a sliding block 60.

The base body 10 is formed in a long rod shape.

In this embodiment, the base body 10 is composed of an upper body 11 and a lower body 12 stacked and combined with each other.

When the swing plate 40 is unfolded to be horizontal, the upper body 11 is disposed over the swing plate 40 and the lower body 12 is disposed under the swing plate 40.

As shown in FIG. 2 and FIG. 5, guide protrusions 13 are formed on the base body 10, and in this embodiment, the guide protrusions 13 protrude upward from the lower body 12.

The swing sliders 20 are provided in a pair spaced apart from each other at both sides of the base body 10.

An end of the swing slider 20 is coupled to the base body 10 to be rotatable upward and downward.

The synchronization element 30 synchronizes rotation of the pair of swing sliders 20 spaced apart from each other by connecting them.

In this embodiment, a gear is formed at one end of the swing sliders 20, and the synchronization element 30 is composed of two idle gears engaged with the gears formed at the one end of the swing sliders 20.

A gear cover 35 that supports the swing sliders 20 and the idle gears such that they can be inserted and rotated therein are mounted at both sides of the one ends of the swing sliders 20.

By this coupling structure of the configuration described above, when one swing slider 20 is rotated, the other swing slider 20 is also synchronized and rotated by the synchronization element 30, whereby the pair of swing slider 20 is rotated toward or away from each other.

The swing plates 40 are spaced apart from each other at both sides of the base body 10, and arc-shaped swing cams 41 are formed at an end thereof.

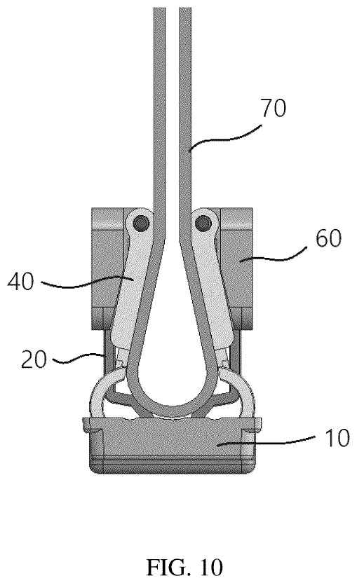

A flexible display 70 that is mounted in a mobile terminal is, as shown in FIG. 10, disposed on the top of the swing plates 40.

The swing cams 41 are formed in a semi-arc shape and are coupled to the base body 10 to be rotatable upward and downward.

In detail, the swing cams 41 are disposed between the upper body 11 and the lower body 12 and are rotatably mounted on the upper body 11.

The swing plates 40 forms a waterdrop shape with a narrow upper portion and a wide lower portion at the portion where the flexible display 70 that is mounted in a mobile terminal is folded when the mobile terminal is closed.

The plate spring 50 is coupled and fixed to the base body 10 with both ends in contact with the outer surface of the pair of spaced swing cams 41.

The outer surface of the swing cams 41 are formed in an arc shape.

The plate spring 50 applies a friction force while always being in contact with the swing cams 41 when the swing plates 40 are rotated such that the swing plates 40 maintain a stop state at a predetermined angle, that is, implement a free stop function.

Elastic protrusions 51 are formed at both ends of the plate spring 50.

Further, two concave grooves 42 in which the elastic protrusions 51 are inserted, respectively, when the swing plates 40 are unfolded to be horizontal, that is, rotated over 90 degrees are formed on the rear surface of the swing cams 41.

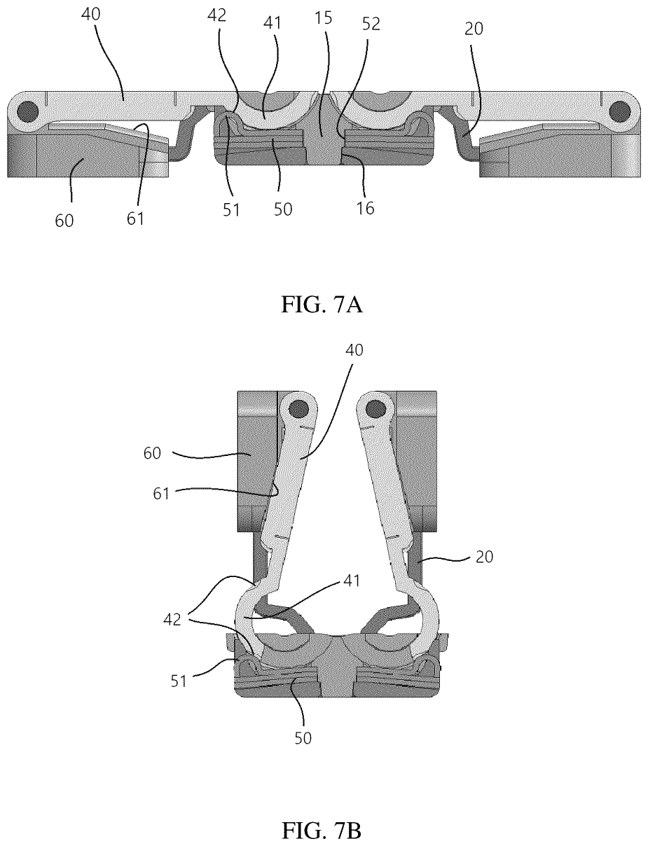

That is, as shown in FIG. 7A, the elastic protrusions 51 are inserted in one of the concave grooves 42 when the swing plates 40 are unfolded to be horizontal.

Further, as shown in FIG. 7B, the elastic protrusions 51 are inserted in the other one of the concave grooves 42 when the swing plates 40 are folded by rotating over 90 degrees.

When the swing plates 40 are rotated, the elastic protrusions 51 are inserted into the concave grooves 42, so it is possible to provide clicking feedback to a user. Further, when the elastic protrusions 51 approach the concave grooves 42, the elastic protrusions 51 are inserted into the concave grooves 42 by sliding such that the swing plates 40 can be naturally rotated by a predetermined angle.

Further, the swing plates 40 are not unexpectedly rotated when the elastic protrusions 51 inserted in the concave grooves 42, that is, the pair of swing plates 40 horizontally unfolded or folded.

The plate spring 50 can be fixed in various ways, and in this embodiment, the plate spring 50 is fixed to the base body 10 by coupling of the upper body 11 and the lower body 12.

In detail, as shown in FIGS. 2, 3, and 7A, fixing protrusions 15 protrude downward from the upper body 11, through-holes 52 are formed at the plate spring 50, and fastening holes 16 are formed at the lower body 12.

When the upper body 11 and the lower body 12 are coupled, the fixing protrusions 15 pass through the through-holes 52 and the fastening holes 16 to fix the plate spring 50.

Accordingly, the plate spring 50 can be naturally fixed by coupling the upper body 11 and the lower body 12 without fixing it using separate screws, etc., so the assembly process can be reduced.

The slide block 60 is hinged at the upper end to the swing plate 40 to be rotatable, and the swing slider 20 is slidably coupled to the lower end thereof.

The slide block 60 is coupled and fixed to a mobile terminal.

By the configuration and structure described above, as shown in FIG. 7A to FIG. 9B, in a state in which the hinge module is unfolded, when the hinge module and a mobile terminal are closed, that is, the swing plates 40 at both sides are rotated toward each other with the swing cams 41 therebetween, the slide blocks 60 formed at the swing plates 40 are rotated with the swing plates 40.

By rotation of the swing block 60, the swing slider 20 passing through the slide block 60 slides out of the slide block 60 and rotates with the slide block 60.

When any one of the swing sliders 20 is rotated, the other swing slide 20 is also rotated by the synchronization element 30.

In this case, the plate spring 50 comes in contact with the swing cam 41 and applies elastic force such that the swing plate 40 maintains a predetermined angle.

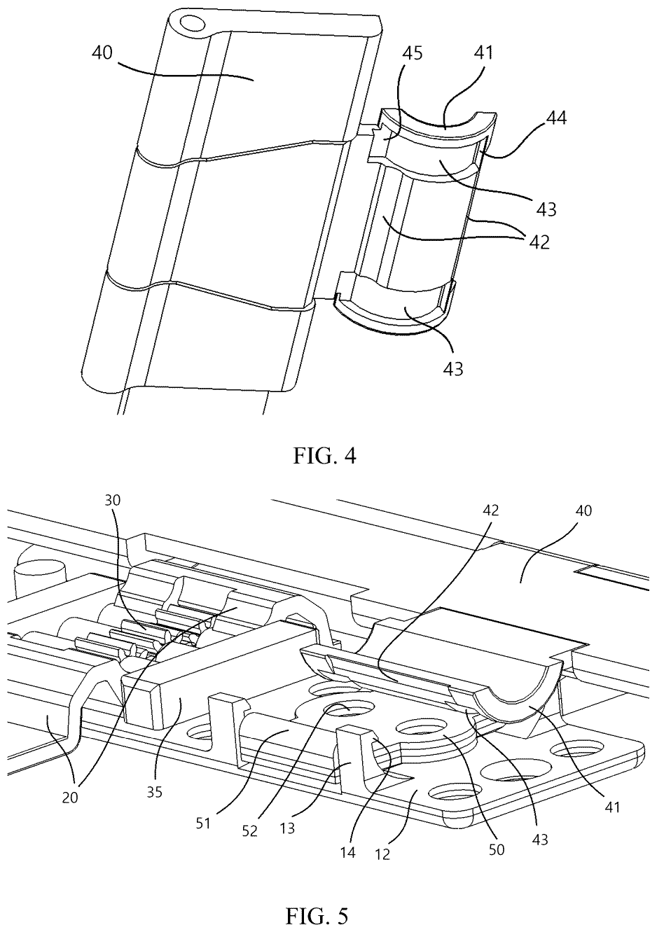

As shown in FIGS. 4, 6, 8A, and 8B, a guide groove 43 is formed in an arc shape on the outer surface of the swing cam 41 formed in a semi-arc shape along the outer surface of the swing cam 41.

Further, guide protrusions 13 that are inserted in the guide grooves 43 when the swing plate 40 is rotated is formed on the base body 10, in detail, the lower body 12, as shown in FIGS. 2, 5, 7A, 7B, 8A and 8B.

The guide grooves 43 and the guide protrusions 13 may be formed at various positions, and in this embodiment, the guide grooves 43 are formed at both sides of the center portion of the swing cam 41 that is in contact with the plate spring 50, and the guide protrusions 13 protrude at both side of the plate spring 50.

By the guide protrusions 13 and the guide grooves 43 described above, when the sing plate 40 is rotated, the swing plate 40 can be more stably rotated without shaking.

As shown in FIGS. 4, 5, 8A, and 8B, a first locking step 14 is formed on the guide block 13, a second locking step 44 is formed at an end of the guide groove 43, and a supporting step 45 is formed at the other end of the guide groove 43.

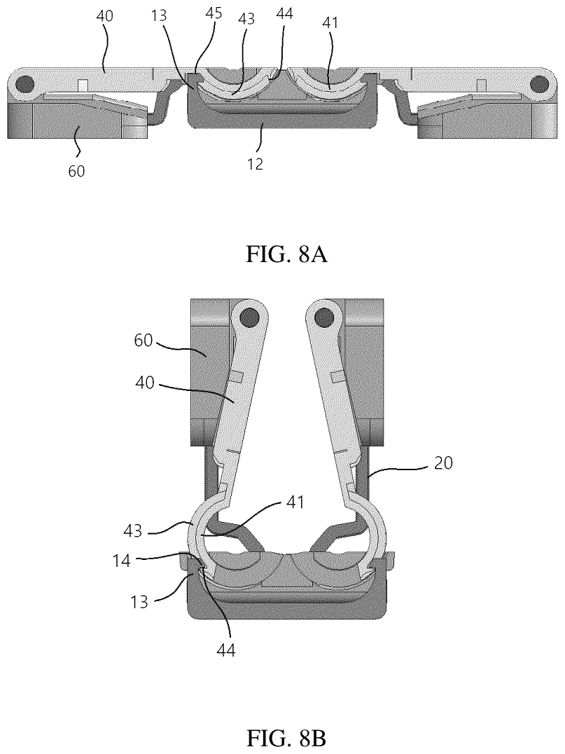

As shown in FIG. 8B, when the swing plate 40 is rotated over 90 degrees (rotated at about 102 degrees), the second locking step 44 comes in contact with the first locking step 14, thereby limiting the rotation angle of the swing plate 40.

As shown in FIG. 8A, when the swing plate 40 is rotated to be horizontally unfolded, the supporting step 45 of the swing cam 41 comes in contact with the first locking step 14 such that the swing plate 40 maintains the horizontally unfolded state.

By the first locking step 14, the second locking step 44, and the supporting step 45 described above, when the swing plate 40 is fully folded or horizontally unfolded, the swing plate 40 can maintain the angle without exceeding a preset angle.

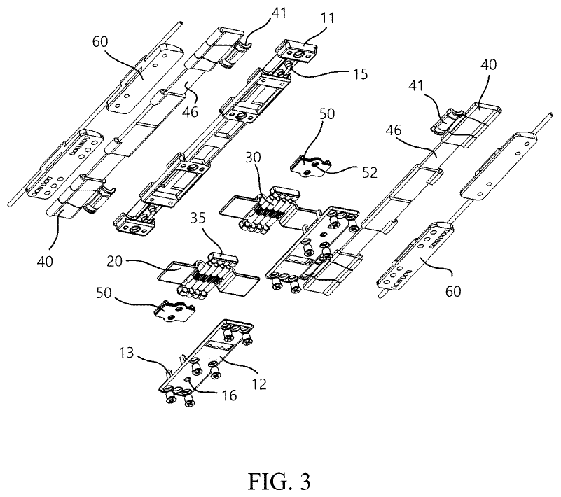

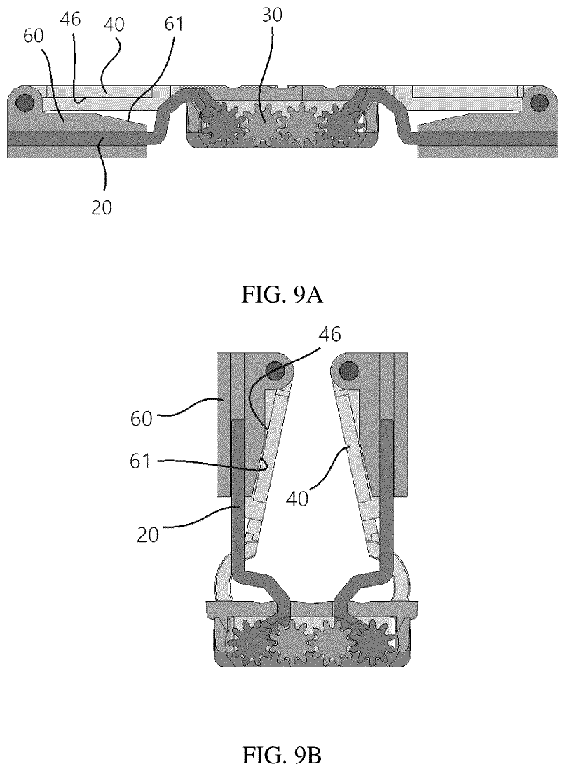

Further, as shown in FIGS. 3, 9A, and 9B, a seating groove 46 is concavely formed on the other surfaces that are surfaces opposite of one surfaces facing each other of the pair of swing plates 40.

As shown in FIG. 9B, when the swing plate 40 is rotated over 90 degrees, the slide block 60 is rotated about the upper end hinged to the swing plate 40, whereby it supports the swing plate 40 while it is inserted in the seating groove 46.

In detail, as shown in FIG. 9A, the slide block 60 is not inserted in the seating groove 46 with the swing slider 20, the swing plate 40, and the slide block 60 horizontally unfolded.

In this state, when the swing slider 20 and the slide block 60 are rotated 90 degrees from the horizontal state, as shown in FIG. 9B, the slide block 60 is inserted into the seating groove 46 while rotating about the upper end hinged to the swing plate 40, thereby supporting the swing plate 40 rotated over 90 degrees such that the swing plate 40 maintains the angle stably without shaking.

In this case, the slide block 60 and the swing slider 20 coupled to a mobile terminal is rotated 90 degrees from the horizontal state by external force, and the swing plate 40 is rotated over 90 degrees from the horizontal state.

By rotation of the pair of swing plates 40 over 90 degrees like the operation described above, as shown in FIG. 10, the folding portion of the flexible display 90 can stably form a waterdrop shape with a narrow upper portion and a wide lower portion.

Further, an inclined surface 61 is formed on one surface of the slide block 60 that faces the other surface of the swing plate 40.

When the swing plate 40 is rotated over 90 degrees, the inclined surface 61 of the slide block 60 comes in contact with the other surface of the swing plate 40 disposed at an angle, thereby safely supporting the swing plate 40 in a larger area.

When the hinge module of the present disclosure described above is applied to a foldable mobile terminal, it is possible to stably form a waterdrop shape with a narrow upper portion and a wide lower portion at the center portion, that is, the folding portion of the flexible display 70 when the foldable mobile terminal is folded, as shown in FIG. 10.

Further, the present disclosure enables a mobile terminal to be stably rotated by the guide groove 43 formed at the swing cam 41 of the swing plate 40 and the guide protrusion 13 formed at the base body 10, and enables the mobile terminal to maintain an angle in an unfolded state or folded state.

The waterdrop type hinge module for a foldable mobile terminal that is the present disclosure, and a foldable mobile terminal using the waterdrop type hinge module are not limited to the embodiment described above and can be modified in various ways within the allowable range of the spirit of the present disclosure.

### REFERENCE SIGNS LIST

10: Base body
11: Upper body
12: Lower body
13: Guide protrusion
14: First locking step
15: Fixing protrusion
16: Fastening hole
20: Swing slider
30: Synchronization element
35: Gear cover
40: Swing plate
41: Swing cam
42: Concave groove
43: Guide groove
44: Second locking step
45: Supporting step
46: Seating groove
50: Plate spring
51: Elastic protrusion
52: Through-hole
60: Slide block
61: Inclined surface
70: Flexible display

1. A waterdrop type hinge module for a foldable mobile terminal, comprising:
a base body;
a pair of swing sliders spaced apart from each other at both sides of the base body and coupled at one end to the base body to be rotatable upward and downward;
a synchronization element synchronizing rotation of the pair of swing sliders spaced apart from each other by connecting the swing sliders;
a pair of swing plates spaced apart from each other at both sides of the base body, having an arc-shaped swing cam formed at an end and coupled to the base body to be rotatable upward and downward, and forming a waterdrop shape with a narrow upper portion and a wide lower portion at a folding portion of a flexible display mounted in a mobile terminal when the mobile terminal is closed;
a plate spring coupled and fixed to the base body and being in contact with an outer surface of the pair of spaced swing cams at both ends; and
a slide block hinged at an upper end to the swing plate to be rotatable, having the swing slider coupled to a lower end to be slidable, and coupled and fixed to the mobile terminal,
wherein a guide groove is formed on an outer surface of the swing cams along the outer surface of the swing cams and guide protrusions that are inserted in the guide grooves when the swing plates are rotated are formed on the base body.

2. The waterdrop type hinge module of claim 1,
wherein the guide grooves are formed at both sides of a center potion of the swing cam that is in contact with the plate spring, and
the guide protrusions protrude at both sides of the plate spring.

3. The waterdrop type hinge module of claim 1,
wherein the base body is formed by coupling an upper body disposed over the swing cam and a lower body disposed under the swing cam, and
the guide protrusions protrude upward from the lower body.

4. The waterdrop type hinge module of claim 3,
wherein fixing protrusions protrude downward from the upper body,
through-holes are formed at the plate spring,
fastening holes are formed at the lower body, and
when the upper body and the lower body are coupled, the fixing protrusions pass through the through-holes and the fastening holes to fix the plate spring.

5. The waterdrop type hinge module of claim 1,
wherein a first locking step is formed at the guide protrusion,
a second locking step is formed at an end of the guide groove, and
when the swing plate is rotated over 90 degrees, the second locking step comes in contact with the first locking step, thereby limiting a rotation angle of the swing plate.

6. The waterdrop type hinge module of claim 5,
wherein a supporting step is formed at the other end of the guide groove, and
when the swing plate is unfolded to be horizontal, the supporting step comes in contact with the first locking step such that the swing plate maintains the horizontally unfolded state.

7. The waterdrop type hinge module of claim 1,
wherein a seating groove is formed on the other surfaces that are surfaces opposite of one surfaces facing each other of the pair of swing plates, and
when the swing plate is rotated over 90 degrees, the slide block is rotated about an upper end hinged to the swing plate and is inserted into the seating groove, thereby supporting the swing plate.

8. The waterdrop type hinge module of claim 7,
wherein an inclined surface is formed on the one surface facing the other surface of the swing plate, and
when the swing plate is rotated over 90 degrees, the inclined surface of the slide block comes in contact with the other surface of the swing plate that is disposed at an angle.

9. The waterdrop type hinge module of claim 1,
wherein when the folding portion of a flexible display is formed in a waterdrop shape with a narrow upper portion and a wide lower portion by the pair of swing plates,
the slide block and the swing slider coupled to the mobile terminal is rotated 90 degrees from a horizontal state, and
the swing plate is rotated over 90 degrees from a horizontal state.

10. A foldable mobile terminal equipped with the hinge module of claim 1.
